(19) United States
(12) Patent Application Publication
(10) Pub. No.: US 2025/0275622 A1
(43) Pub. Date: Sep. 4, 2025

(54) REMOVABLE BRUSH HEAD FOR ELECTRIC TOOTHBRUSH

(71) Applicant: Oralic Supplies, Inc., Diamond Bar, CA (US)

(72) Inventor: Jun Lee, Irvine, CA (US)

(21) Appl. No.: 18/593,585

(22) Filed: Mar. 1, 2024

(51) Int. Cl. A46B 5/00; A61C 17/34

(52) U.S. Cl. CPC A46B 5/0095; A61C 17/34; A46B 2200/1066

(57) ABSTRACT

This document discloses a toothbrush head for an electric toothbrush. The toothbrush head a brush section having a plurality of bristles attached thereon, a stem having an opening for receiving a driveshaft of an electric toothbrush, and a motion transmission assembly disposed within the stem. The motion transmission assembly includes a spring and an elongated motion arm having a distal end portion and proximal end portion, the distal end portion being coupled to the brush section. The spring is configured to bias the elongated motion arm in a proximal direction relative to the stem.

### BACKGROUND

This disclosure relates to the field of electric toothbrushes, and particularly brush heads that are configured to couple to an electric toothbrush handle.

Many types of electric toothbrushes use vibrations or oscillations of a motor inside the toothbrush handle to drive the brush head. In order to operate the electric toothbrush, the construction of the brush head requires that it be tightly coupled to the driveshaft of the toothbrush handle so it can withstand oscillations and also transfer the motion of the driveshaft to brush portion (e.g., to rotate the brush portion). Some existing products incorporate magnets to achieve such coupling. However, this can, for example, increase the cost of making the brush head and increase the weight of the brush head. Additionally, uncovered magnets or magnetic materials can encourage corrosion because of the environmental moisture associated with toothbrush use.

This patent document describes an apparatus that addresses at least some of the issues described above and/or other issues.

### SUMMARY

In a first aspect, this disclosure relates to a toothbrush head for an electric toothbrush. The toothbrush head can include a brush section having a plurality of bristles attached thereon, a stem having an opening for receiving a driveshaft of an electric toothbrush, and a motion transmission assembly disposed within the stem. The motion transmission assembly can include a first spring, an elongated motion arm having a distal end portion and proximal end portion, the distal end portion being coupled to the brush section, a driveshaft receiver engaged with the proximal end portion of the elongated motion arm, and a second spring biasing the elongated motion arm and the driveshaft receiver apart from each other and configured to transfer motion from the driveshaft receiver to the elongated motion arm. The first spring can be configured to bias the elongated motion arm in a proximal direction relative to the stem.

The driveshaft receiver can include a proximal end having a shaft coupling portion and a distal end having a cavity. The second spring can be disposed within the cavity of the driveshaft receiver. The proximal end of the elongated motion arm comprises a sidewall forming a cavity sized and shaped to receive the distal end of the driveshaft receiver.

In some embodiments, the distal end of the driveshaft receiver can further include comprises a protrusion, the side wall of the proximal end of the elongated motion arm can include a slot, and the protrusion of the driveshaft receiver can engage the slot and can be configured to limit a range of relative motion between the driveshaft receiver and the elongated motion arm.

In some embodiments, the elongated motion arm can be eccentrically coupled to the brush section and can be configured to cause rotation of brush section in response to movement of the elongated motion arm. In some embodiments, the first spring is disposed around a portion of the elongated motion arm. In further embodiments, the driveshaft receiver further includes a plurality of lugs. In some embodiments, the toothbrush head further includes a coupling member disposed within the stem. The coupling member can further include a sidewall forming a body of the coupling member and defining an opening for receiving the driveshaft, and a longitudinal slot formed in the sidewall and configured to receive an indexing ridge and pin of the driveshaft.

In another aspect, this document relates a toothbrush head for an electric toothbrush, the toothbrush head including a brush section having a plurality of bristles attached thereon, a stem having an opening for receiving a driveshaft of an electric toothbrush, and a motion transmission assembly disposed within the stem. The motion transmission assembly can include a spring, and an elongated motion arm having a distal end portion and proximal end portion, the distal end portion being coupled to the brush section. The spring can be configured to bias the elongated motion arm in a proximal direction relative to the stem. In some embodiments, the motion transmission assembly can further include an elastomeric pad disposed between the proximal end portion of the elongated motion arm and the driveshaft.

In some embodiments, the proximal end portion of the elongated motion arm can include a shaft coupling portion. The shaft coupling portion can further include a plurality of lugs. The lugs can be configured to engage with corresponding receptacles of the driveshaft.

In further embodiments, the elongated motion arm can be eccentrically coupled to the brush section and can be configured to cause rotation of brush section in response to movement of the elongated motion arm. In some embodiments, the toothbrush head can further include a coupling member disposed within the stem. The coupling member can include a sidewall forming a body of the coupling member and defining an opening for receiving the driveshaft, and a longitudinal slot formed in the sidewall and configured to receive an indexing ridge and pin of the driveshaft. In some embodiments, the spring can be disposed around a portion of the elongated motion arm. In further embodiments, the elongated motion arm can include two distinct members.

### BRIEF DESCRIPTION OF THE DRAWINGS

FIG. 1 is a perspective view of an example interior structure of an example toothbrush head.

FIGS. 2A and 2B are perspective views of an example toothbrush head coupling member.

FIG. 3 is a perspective view of a portion of the example interior structure of a toothbrush head of FIG. 1.

FIG. 4 is a perspective view of a portion of the example interior structure of a toothbrush head of FIG. 1.

FIG. 5 is a perspective view of a portion of the example interior structure of a toothbrush head of FIG. 1.

FIG. 6 is a cross-sectional side view of a portion of the example interior structure of a toothbrush head of FIG. 1.

FIG. 7 is a cross-sectional side view of an example toothbrush head.

FIG. 8 is a cross-sectional rear view of the toothbrush head of FIG. 7.

FIG. 9 is a perspective cross-sectional view of a toothbrush head without a motion transmission assembly.

FIG. 10 is a perspective view of another example interior structure of an example toothbrush head.

FIGS. 11A and 11B are perspective views of another example toothbrush head coupling member.

FIG. 12 is a perspective view of a portion of the example interior structure of a toothbrush head of FIG. 10.

FIG. 13 is a perspective view of a portion of the example interior structure of a toothbrush head of FIG. 10.

FIG. 14 is a partially exploded view illustrating how a brush head and its components may attach to a toothbrush handle.

FIG. 15 is a perspective view of an example assembled electric toothbrush.

FIG. 16 is a partially exploded view of the assembled electric toothbrush of FIG. 15.

FIG. 17 is a perspective view of an example driveshaft of the electric toothbrush of FIG. 15.

FIG. 18 is a perspective view of another example interior structure of an example toothbrush head.

FIG. 19A is a perspective view of a portion of the example interior structure of a toothbrush head of FIG. 18.

FIG. 19B is a perspective view of a portion of the example interior structure of a toothbrush head of FIG. 18.

FIG. 20A is a perspective view of a portion of an example structure of a toothbrush head.

FIG. 20B is another perspective view of a portion of an example structure of a toothbrush head.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun, such use is simply intended to distinguish one item from another, and is not intended to require a sequential order unless specifically stated. The term “approximately,” when used in connection with a numeric value, is intended to include values that are close to, but not exactly, the number. For example, in some embodiments, the term “approximately” may include values that are within +/−10 percent of the value.

In this document, the term “connected”, when referring to two physical structures, means that the two physical structures touch each other. Devices that are connected may be secured to each other, or they may simply touch each other and not be secured.

When used in this document, terms such as “top” and “bottom,” “upper” and “lower”, or “front” and “rear,” are not intended to have absolute orientations but are instead intended to describe relative positions of various components with respect to each other. For example, a first component may be an “upper” component and a second component may be a “lower” component when a device of which the components are a part is oriented in a first direction. The relative orientations of the components may be reversed, or the components may be on the same plane, if the orientation of the structure that contains the components is changed. The claims are intended to include all orientations of a device containing such components.

This disclosure is not limited to the particular systems, methodologies or protocols described, as these may vary. The terminology used in this description is for the purpose of describing the particular versions or embodiments only, and is not intended to limit the scope.

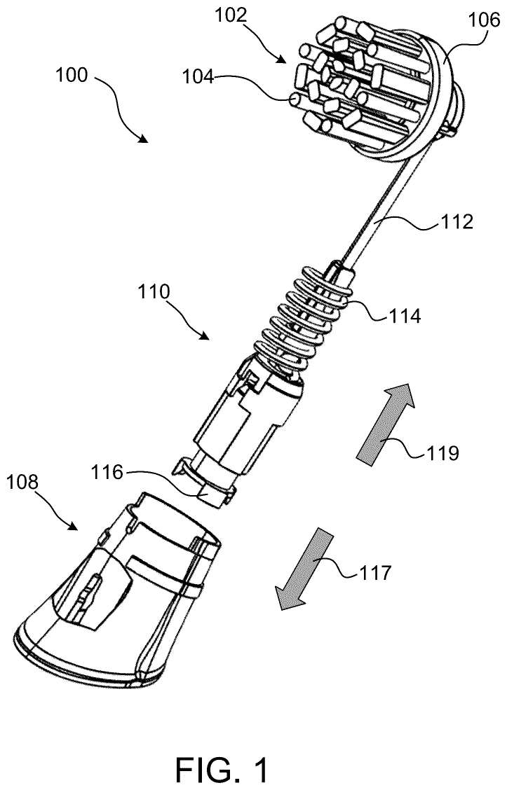

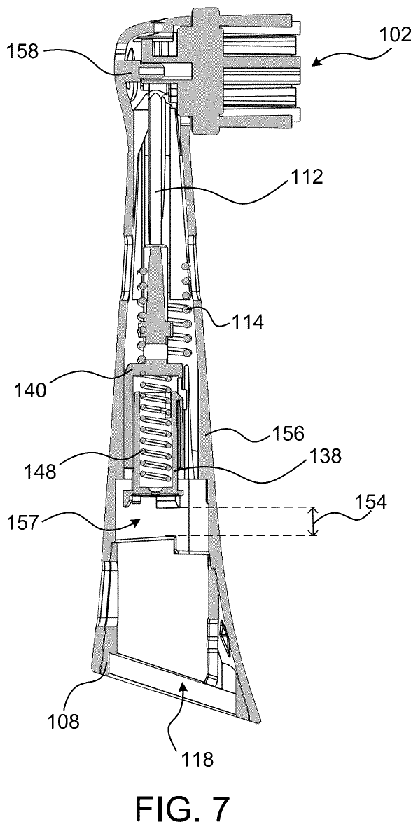

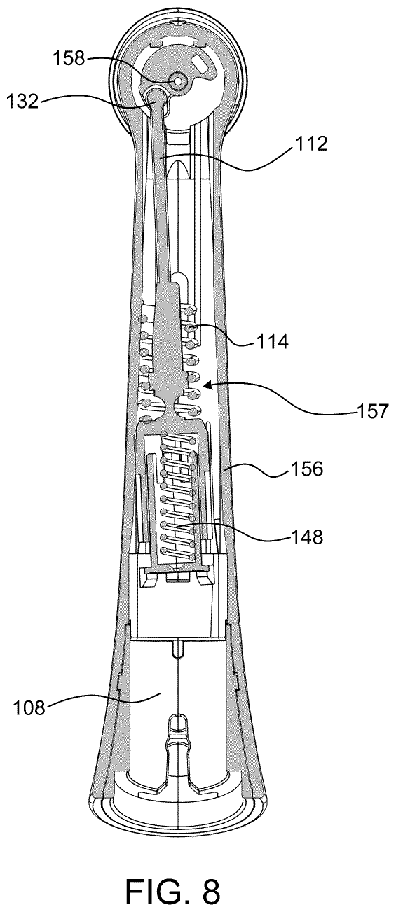

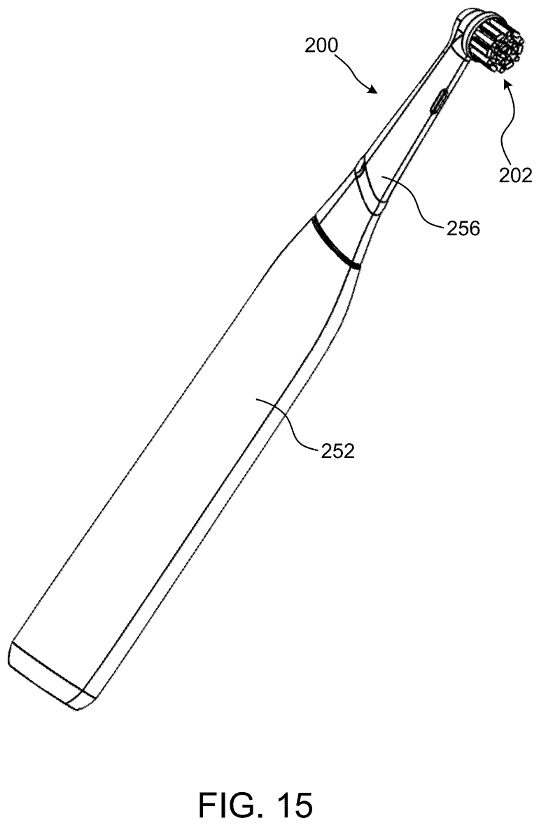

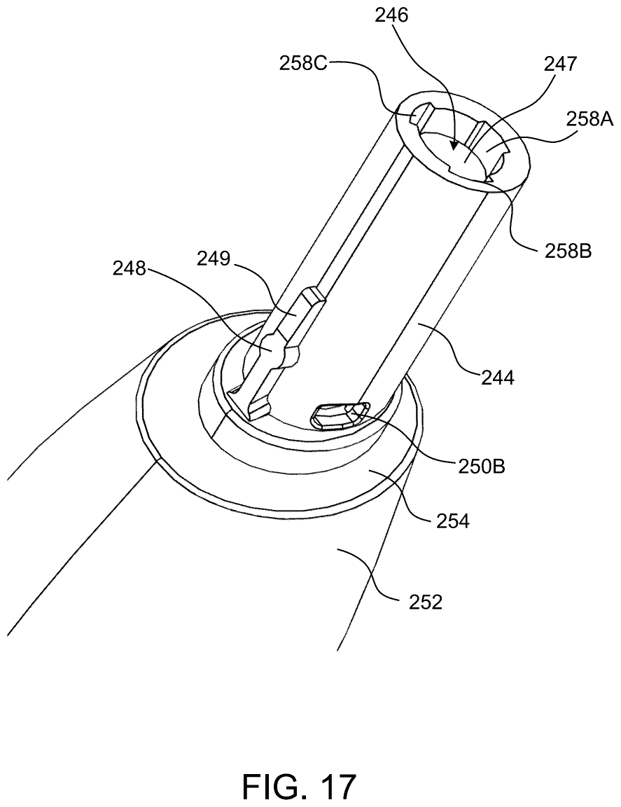

In various embodiments, a brush head is couplable to a drive shaft of an electric toothbrush handle, as shown in FIG. 15-17 and described in greater detail below. Referring to FIGS. 1, 3, and 7-9, brush head 100 is a removable component attachable to a drive shaft of an electric toothbrush handle (not shown). Brush head 100 can be an original component of an electric toothbrush assembly, or can be a separate replacement component. Brush head 100 includes a brush section 102, a stem 156, and motion transmission assembly 110 within the stem 156. Brush head 100 can further include a coupling member 108 disposed within the stem. As shown in, for example, FIGS. 7 and 8, motion transmission assembly 110 and coupling member 108 can be disposed in cavity 157 of stem 156. Coupling member 108 includes a proximal end opening 118 configured to receive the driveshaft (for example, driveshaft 244 shown in, e.g., FIG. 17. As used herein, the proximal direction is indicated by arrow 117 in FIG. 1. The distal direction is indicated by arrow 119 and is generally the end closest to the brush bristles. Various parts of the brush head including the stem 156, elongated motion arm 112, driveshaft receiver 116, and bristle carrier 104 may be formed of various materials, but are preferably molded plastic or polyester materials, such as, for example, polyoxymethylene, polyvinylchloride, etc.

Brush section 102 can include a bristle plate 106 and one or more bristle tufts 104. Bristle plate 106 can include a plurality of openings configured to retain a plurality of flexible brush bristles forming bristle tufts 104. The brush bristles may be retained in the openings of the bristle plate 106 through any appropriate retention method, including, but not limited to, weaving, tying, adhesive retention, welding, crimping, etc. In some embodiments, brush section 102 can, additionally or alternatively, include one or more flossing structures (not shown). Flossing structures can be semi-rigid structures configured to act alone or concert with the flexible brush bristles during use of the electric toothbrush.

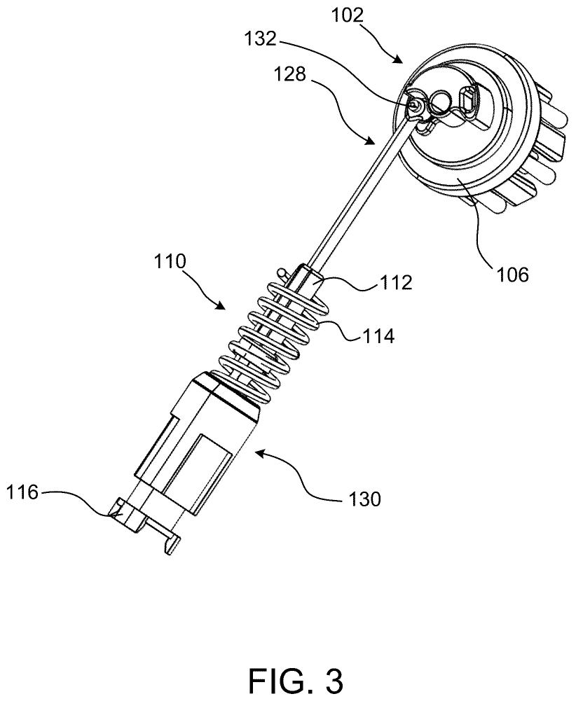

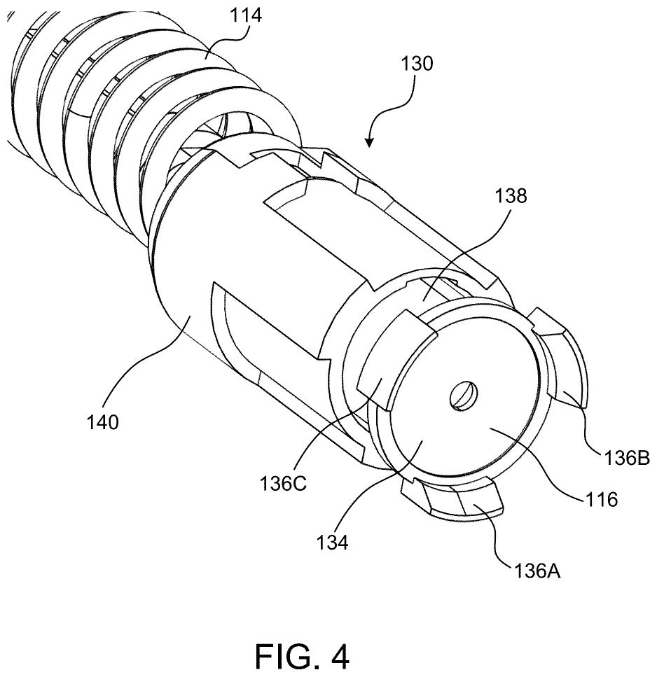

Referring to FIGS. 3-8, motion transmission assembly 110 includes an elongated motion

arm 112, a first spring 114, and a driveshaft receiver 116. Elongated motion arm 112 can extend longitudinally within the stem 156 and include a proximal end portion 130 and a distal end portion 128. Motion transmission assembly 110 is configured to receive substantially linear (i.e., longitudinal) motion from the driveshaft and turn the linear motion into rotational motion of the brush section. For example, the brush section can rotate about an axis transverse to the longitudinal axis of the stem 156 of the brush head. Specifically, as illustrated in e.g., FIG. 7, bristle plate 106 can rotate about bristle plate pin 158. Bristle plate pin 158 can be integrally formed in to stem 156. In other embodiments (not shown), bristle plate pin 158 can be integrally formed into bristle plate 106 and be received in a corresponding cavity of stem 156. In other embodiments, bristle plate pin 158 can be a separate piece from both bristle plate 106 and stem 156. Elongated motion arm 112 can be eccentrically attached to brush section 102 (i.e., bristle plate 106) at attachment point 132. The eccentric attachment permits the linear motion of elongated motion arm 112 to be transferred into rotational motion of the bristle plate 106. The eccentric attachment can be achieved using a pin and slot or similar attachment. For example, a pin of elongated motion arm 112 can be inserted into slot 162 of brush section 102.

The proximal end 130 of elongated motion arm 112 can include a sidewall 140 extending from an arm portion. Sidewall 140 can be cylindrical (as shown in the figures) or could take other cross-sectional shapes, including by not limited to a square, rectangle, oval, and triangle. Sidewall 140 can extend proximally from the arm portion of elongated motion arm 112 and form a cavity 152. Sidewall 140 can include a slot 142 formed in the sidewall 140 to receive a protrusion 144 of the driveshaft receiver, as described in greater detail below.

The driveshaft receiver 116 can include a proximal end having a shaft coupling portion and a distal end having a cavity. The shaft coupling portion can include a driveshaft contact surface 134. Driveshaft contact surface 134 can be a substantially flat (i.e., planar) surface that contacts a distal top of the toothbrush handle driveshaft. Driveshaft receiver 116 can further include plurality of lugs 136A-C. Lugs 136A-C can be indexing lugs configured to engage corresponding cavities of the toothbrush handles driveshaft (e.g., cavities 258A-C as shown in FIG. 17). The lugs can reduce excess noise and vibration of the internals of the toothbrush head by limiting rotational motion of the motion transmission assembly relative to the driveshaft. The lugs also ensure that the drive shaft receiver 116 is center on the driveshaft when the toothbrush head is installed, thus ensuring efficient motion transmission between the driveshaft and toothbrush head. While three equally spaced lugs 136A-C are shown in the figures, it is understood that more or fewer lugs with varying spacing could be implemented in various embodiments. The driveshaft receiver 116 can futher include a sidewall 138. Sidewall 138 can extend longitudinally from drive shaft contact surface 134 and form a cavity 150. Sidewall 138 can further include a protrusion 144.

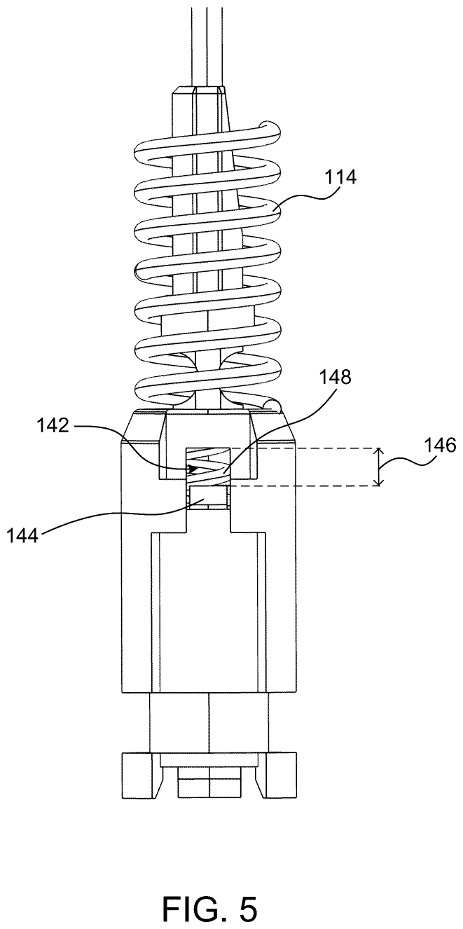

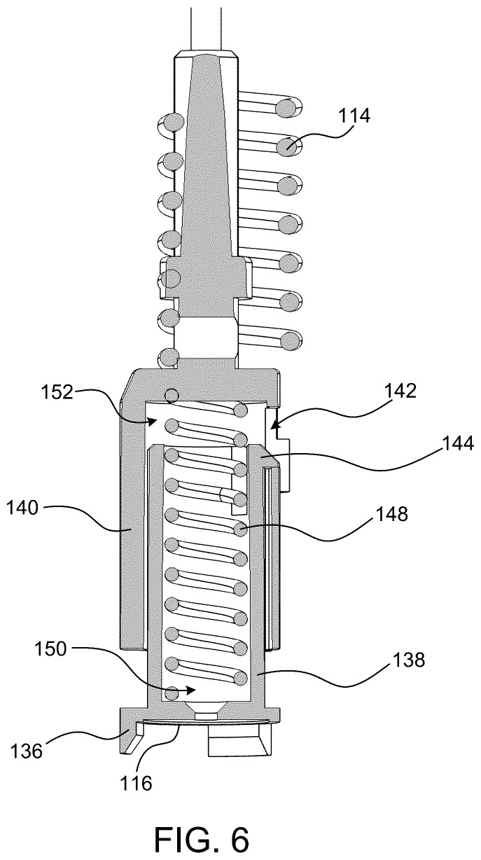

Driveshaft receiver 116 can be engaged with the proximal end portion 130 of the elongated motion arm 112. Sidewall 140 (which forms cavity 152) is sized and shaped to receive the distal end of the driveshaft receiver (including at least a portion of sidewall 138). Specifically, sidewall 138 can be at least partially disposed with cavity 152 of elongated motion arm 112. A second spring 148 is disposed within cavity 150 of the driveshaft receiver. The second spring is a compression spring that biases elongated motion arm 112 and driveshaft receiver 116 apart from each other. In other words, the spring is compressed between elongated motion arm 112 and driveshaft receiver 116 and pushes the elongated motion arm 112 in the distal direction 119 and pushes driveshaft receiver 116 in the proximal direction 117. As shown in, for example, FIGS. 5 and 6, protrusion 144 of driveshaft receiver 116 can engage slot 142 in the sidewall 140 of elongated motion arm 112. Protrusion 144 is configured to limit a range of relative motion (illustrated by distance 146 in FIG. 5) between the driveshaft receiver 116 and the elongated motion arm 112. The range of relative motion 146 will depend on the relative length of slot 142 and longitudinal thickness of protrusion 144. The range of relative motion 146 can be configured based on the dimensions of other components of the toothbrush head, for example, the distance at which eccentric connection point 132 is from the center of bristle plate pin 158, and the desired amount of rotation of bristle plate 106. Similarly, the sizing and corresponding stiffness of first spring 114 and second spring 148 can be determined based on the forces exerted by the driveshaft, the range of relative motion 146, etc.

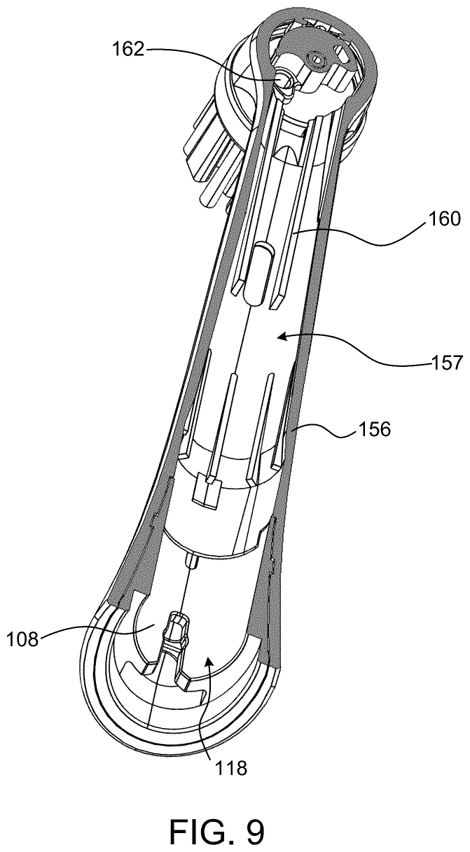

First spring 114 is configured to bias elongated motion arm 112 in a proximal direction relative to the stem 156. In other words, first spring 114 pushes elongated motion arm 112 (and indirectly driveshaft receiver 116) in the proximal direction to ensure contact between driveshaft receiver 116 and the driveshaft. As shown in FIGS. 1 and 3-8, first spring 114 is disposed around a portion of elongated motion arm 112. As shown in FIG. 9, the inside of stem 156 can include one or more ribs 160. In addition to providing structural reinforcement for stem 156, ribs 160 can be positioned and otherwise configured to contact a distal end of first spring 114.

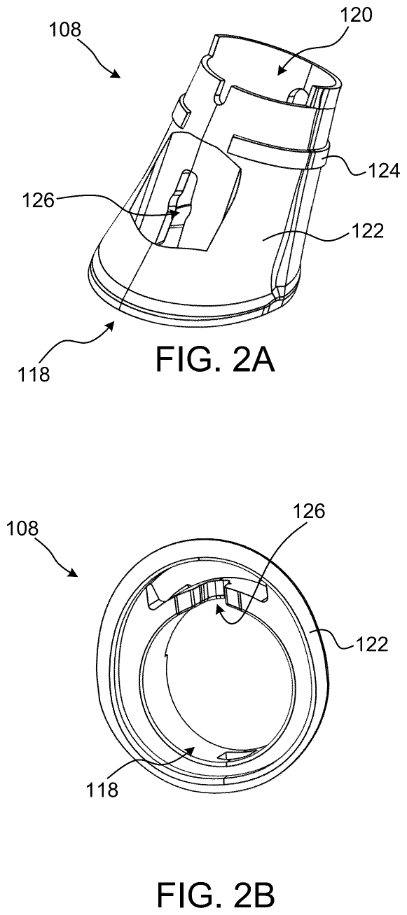

Referring back to FIGS. 1, 2A, and 2B, the brush head can be couplable to the drive shaft using a coupling member 108 that is received within the brush head. The coupling member is the structure that will receive and attach near a base (i.e., a proximal portion) of the drive shaft of the electric toothbrush handle. Coupling member 108 can include a sidewall 122 forming the body of the coupling member. Sidewall 122 can include one or more mounting blocks 124. Coupling member 108 can include a distal end opening 120 defined by the sidewall 112 through with the driveshaft of the toothbrush handle can extend. Coupling member 108 can further include a proximal end opening 118 defined by the sidewall 112 through with the driveshaft of the toothbrush handle can extend.

Coupling member 108 can further include a longitudinal slot 126 configured to receive an indexing ridge and pin of the driveshaft. During installation, the pin can slide through the proximal portion of longitudinal slot 126 and lock into the widened central portion of longitudinal slot 126, which can be sized and shaped to receive and hold the driveshaft pin (e.g., pin 248 of driveshaft 244 as shown in FIG. 17). Referring to FIG. 7-9, the coupling member can be positioned within interior cavity 157 of stem 156, specifically at the proximal end of stem 156. One or more mounting blocks 124 on the outside of coupling member 108 can engage with corresponding receptacles in cavity 157 of stem 156 to secure coupling member 108. A gap 154 can exist between the distal end opening 120 of coupling member 108 and driveshaft receiver 116.

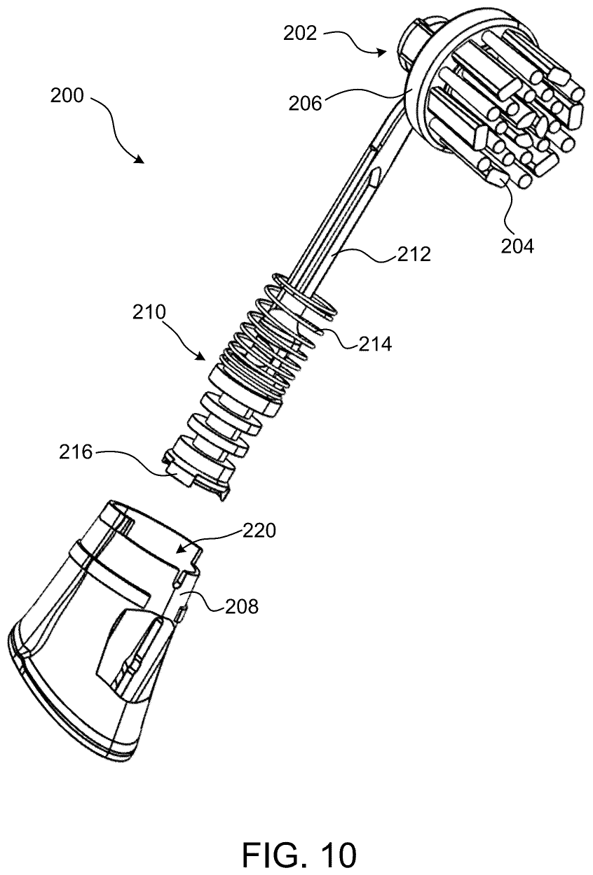

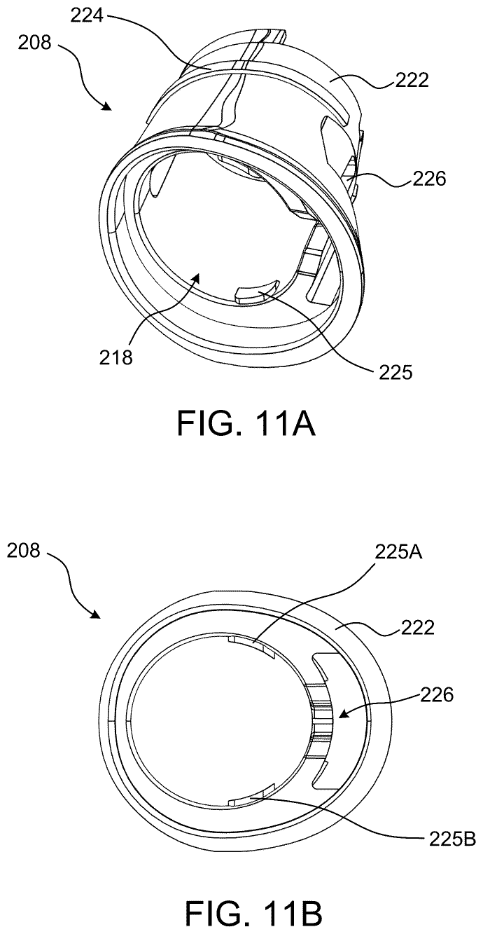

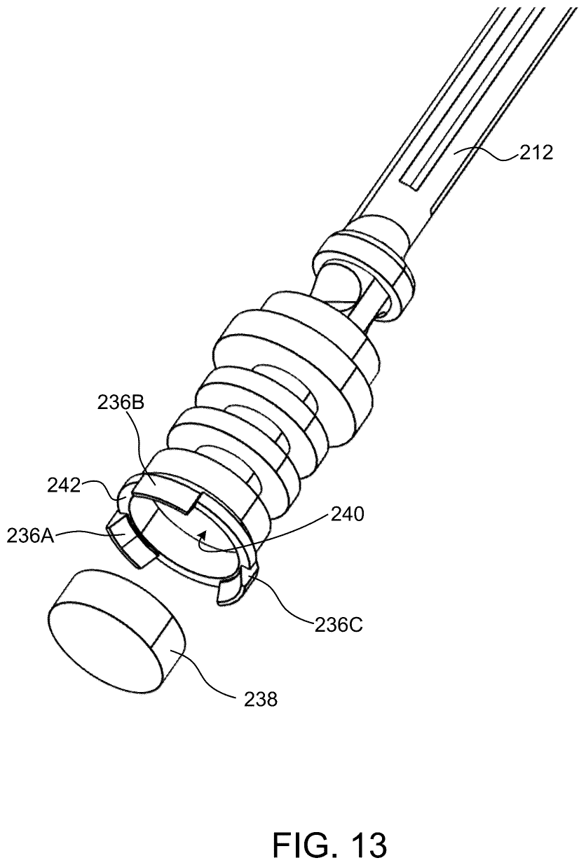

FIGS. 10-14 illustrate another embodiment of a toothbrush head 200. Brush head 200 is a removable component attachable to a drive shaft of an electric toothbrush handle. Brush head 200 can be an original component of an electric toothbrush assembly, or can be a separate replacement component. Brush head 200 includes a brush section 202, a stem 256, and motion transmission assembly 210 within the stem 256. Brush head 200 can further include a coupling member 208 disposed within the stem. As shown in, for example, FIGS. 7 and 8 with respect to brush head 100, motion transmission assembly 210 and coupling member 208 can be disposed in the cavity of stem 256. Referring to FIGS. 11A and 11B, coupling member 208 includes a proximal end opening 218 configured to receive the driveshaft (for example, driveshaft 244 shown in, e.g., FIG. 17). Various parts of the brush head 200 including the stem 256, elongated motion arm 212, driveshaft receiver 216, and bristle carrier 204 may be formed of various materials, but are preferably molded plastic or polyester materials, such as, for example, polyoxymethylene, polyvinylchloride, etc.

Brush section 202 can include a bristle plate 206 and one or more bristle tufts 204. Bristle plate 206 can include a plurality of openings configured to retain a plurality of flexible brush bristles forming bristle tufts 204. The brush bristles may be retained in the openings of the bristle plate 206 through any appropriate retention method, including, but not limited to, weaving, tying, adhesive retention, welding, crimping, etc. In some embodiments, brush section 202 can, additionally or alternatively, include one or more flossing structures (not shown). Flossing structures can be semi-rigid structures configured to act alone or concert with the flexible brush bristles during use of the electric toothbrush.

Referring to FIGS. 10, 12, and 13, motion transmission assembly 210 includes an elongated motion arm 212 and a spring 214. Elongated motion arm 212 can extend longitudinally within the stem 256 and include a proximal end portion 230 and a distal end portion 228. Distal end portion 228 can be coupled to the brush section. The proximal end portion 230 of the elongated motion arm 212 can include a shaft coupling portion 216.

Motion transmission assembly 210 is configured to receive substantially linear (i.e., longitudinal) motion from the driveshaft and turn the linear motion into rotational motion of the brush section. For example, the brush section can rotate about an axis transverse to the longitudinal axis of the stem 256 of the brush head. Specifically, as illustrated and described above with respect to brush head 100 in FIG. 7, bristle plate 206 can rotate about a bristle plate pin. Elongated motion arm 212 can be eccentrically attached to brush section 202 (i.e., bristle plate 206) at attachment point 232. The eccentric attachment permits the linear motion of elongated motion arm 212 to be transferred into rotational motion of the bristle plate 206. The eccentric attachment can be achieved using a pin and slot or similar attachment, as described above. In some embodiments, elongated motion arm 212 may include an offset portion 234 to achieve the eccentric attachment.

The proximal end 230 of elongated motion arm 212 can include a driveshaft coupling portion extending from an arm portion.

The shaft coupling portion 216 includes a driveshaft receiver cavity 240. Driveshaft contact surface 134 can be cavity formed in the proximal end of shaft coupling portion 216 configured to receive a driveshaft or elastomeric pad 238. Shaft coupling portion 216 can further include plurality of lugs 236A-C. Lugs 236A-C can be indexing lugs configured to engage corresponding cavities of the toothbrush handles driveshaft (e.g., cavities 258A-C as shown in FIG. 17). The lugs can reduce excess noise and vibration of the internals of the toothbrush head by limiting rotational motion of the motion transmission assembly relative to the driveshaft. The lugs also ensure that the drive shaft receiver 116 is center on the driveshaft when the toothbrush head is installed, thus ensuring efficient motion transmission between the driveshaft and toothbrush head. While three equally spaced lugs 236A-C are shown in the figures, it is understood that more or fewer lugs with varying spacing could be implemented in various embodiments.

Motion transmission assembly 210 of brush head 200 can further include an elastomeric pad 238 disposed between the proximal end portion 230 of elongated motion arm 212 and the driveshaft. Elastomeric pad 238 can act as a spring between the driveshaft and elongated motion arm 212 to both transfer motion from the driveshaft to the elongated motion arm 212, but also dampened excess vibration in the brush head during operation. As used herein, an elastomeric pad can be a pad that is resilient and flexible. Elastomeric pad 238 can be made from materials including, but not limited to, silicone, rubber, thermoplastic elastomers, nitrile rubber, neoprene, or other suitable material. In some embodiments, elastomeric pad 238 can be made from one material. However, other embodiments can include an elastomeric pad 238 constructed from multiple materials. The thickness of elastomeric pad 238 pad can vary based on a desired amount of vibration dampening, a desired amount of force transfer from the drive shaft, the particular material used to construct elastomeric pad 238, the speed of the driveshaft movements (and resulting speed of the bristle plate), or other factors.

Spring 214 of motion transmission assembly 210 is configured to bias elongated motion arm 212 in a proximal direction relative to the stem 256. In other words, spring 214 pushes elongated motion arm 212 (and indirectly elastomeric pad 238) in the proximal direction to ensure contact between elongated motion arm 212 and elastomeric pad 238, as well as contact between elastomeric pad 238 and the driveshaft.

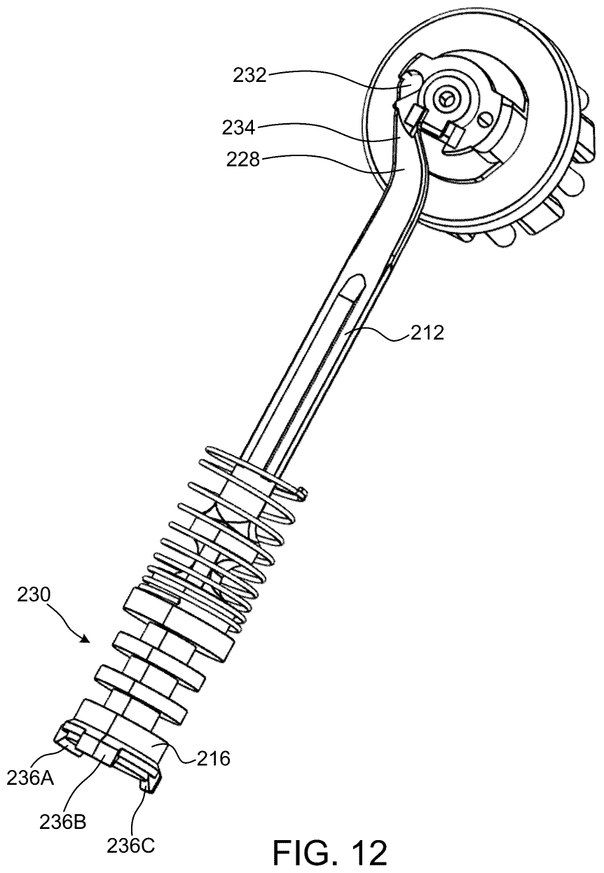

As shown in FIGS. 10 and 12, spring 214 is disposed around a portion of elongated motion arm 212. As shown and described above with respect to brush head 100, the inside of stem 256 can include one or more ribs. In addition to providing structural reinforcement for stem 256, the ribs can be positioned and otherwise configured to contact a distal end of spring 214.

Referring back to FIGS. 10, 11A, and 11B, the brush head 200 can be couplable to the drive shaft using a coupling member 208 that is received within the brush head. The coupling member 208 is the structure that will receive and attach near a base (i.e., a proximal portion) of the drive shaft of the electric toothbrush handle. Coupling member 208 can include a sidewall 222 forming the body of the coupling member. Sidewall 222 can include one or more mounting blocks 224. Coupling member 208 can include a distal end opening 220 defined by the sidewall 222 through with the driveshaft of the toothbrush handle can extend. Coupling member 208 can further include a proximal end opening 218 defined by the sidewall 212 through with the driveshaft of the toothbrush handle can extend.

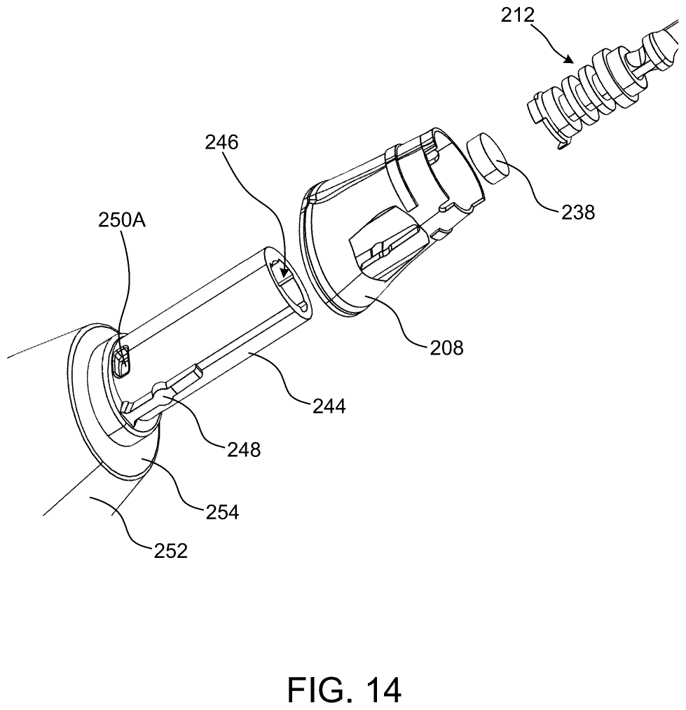

Coupling member 208 can further include a longitudinal slot 226 configured to receive an indexing ridge and pin 248 of the driveshaft. During installation, the pin 248 can slide through the proximal portion of longitudinal slot 226 and lock into the widened central portion of longitudinal slot 226, which can be sized and shaped to receive and hold the driveshaft pin (e.g., pin 248 of driveshaft 244 as shown in FIG. 17). Coupling member 208 can further include one or more interior mounting ridges 225A/B extending from sidewall 222 into the opening formed by coupling member 208. Interior mounting ridges 225A/B can be configured to engage with mounting receptacles 250A/B of driveshaft 244 (shown in FIGS. 14 and 17). Interior mounting ridges 225A/B provide an additional method of securing coupling member 208 to the toothbrush handle (in addition to pin 248 engaging longitudinal slot 226). Coupling member 208 can be positioned within an interior cavity of stem 256, specifically at the proximal end of stem 256. One or more mounting blocks 224 on the outside of coupling member 208 can engage with corresponding receptacles in the cavity of stem 256 to secure coupling member 208. A gap can exist between the distal end opening 220 of coupling member 208 and driveshaft coupling portion 216 of elongated motion arm 212.

FIG. 14 is a partially exploded view illustrating attachment of brush head 200 (not showing the stem 256) to toothbrush handle 252. Toothbrush handle 252 includes a driveshaft 244. Toothbrush handle 252 can further include handle top surface 254, which can contact a proximal surface of brush head 200. Driveshaft 244 can include a coupling pin 248, ridge 249 around coupling pin 248, and one or more mounting receptacles 250A/B. A distal end of drive shaft 244 can include a cavity 246 into which a coupling portion of the brush head can extend.

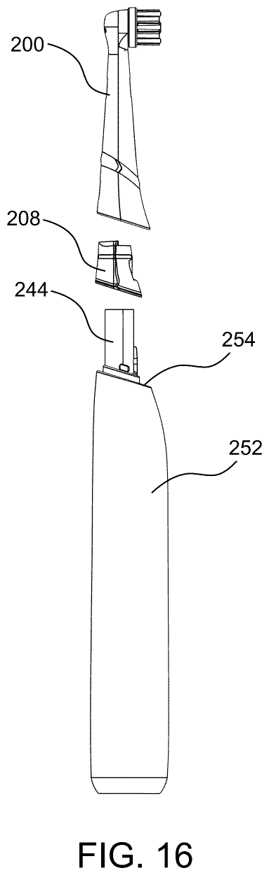

FIG. 15 is a perspective view of a brush handle 252 with installed brush 200 having a stem 256 and brush section 202. FIG. 16 is a partially exploded side view of the toothbrush of FIG. 15, illustrating the brush head 200, coupling member 208, drives shaft 244, handle top surface 254 and toothbrush handle 252.

FIG. 17 is a perspective view of driveshaft 244. As described above, driveshaft 244 can extend from handle top surface 254 of handle 252 and include a coupling pin 248, ridge 249 around coupling pin 248, and mounting receptacles 250A/B. Drive shaft 244 can further include one or more driveshaft lug cavities 258A-C, a cavity 246, and an internal driveshaft 247. Internal driveshaft 247 can be configured to longitudinally oscillate (i.e., move back and forth in the proximal and distal directions). This movement can be transferred to elongated motion arm 112 or 212, as described above to move brush section 102/202 of the brush head.

While the elastomeric pad 238 is only shown and described with respect to brush head 200, it is understood that brush head 100 could be modified to incorporate the addition of an elastomeric pad.

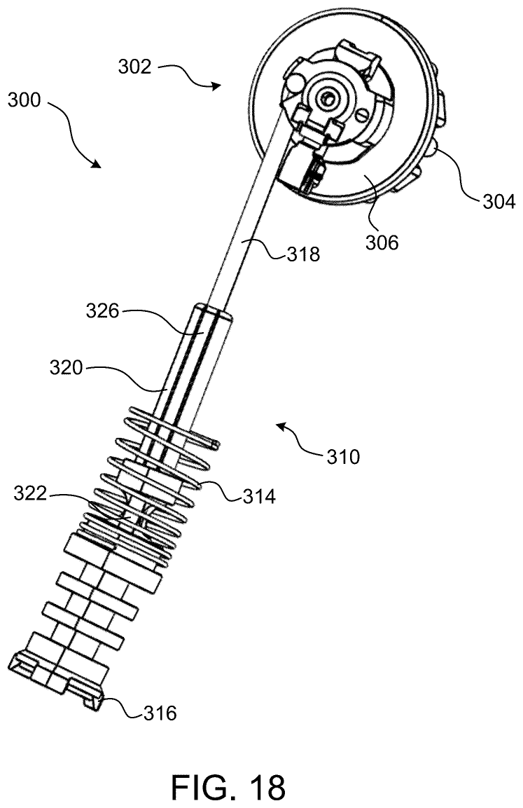

FIG. 18 is a perspective view of the internals of another embodiment of a toothbrush head 300. As described above with respect to brush heads 100, 200, brush head 300 is a removable component attachable to a drive shaft of an electric toothbrush handle. Brush head 300 includes a brush section 302, a stem 346, and motion transmission assembly 310 within the stem 346. As described above with respect to brush heads 100, 200, brush head 300 can further include a coupling member (not illustrated) disposed within the stem. Motion transmission assembly 310 and the coupling member can be disposed in a cavity of stem 346. Various parts of the brush head 300 including the stem 346, elongated motion arm 312, driveshaft receiver 316, and bristle carrier 304 may be formed of various materials, but are preferably molded plastic or polyester materials, such as, for example, polyoxymethylene, polyvinylchloride, etc.

Brush section 302 can include a bristle plate 306 and one or more bristle tufts 304. Bristle plate 306 can include a plurality of openings configured to retain a plurality of flexible brush bristles forming bristle tufts 304. The brush bristles may be retained in the openings of the bristle plate 306 through any appropriate retention method, including, but not limited to, weaving, tying, adhesive retention, welding, crimping, etc. In some embodiments, brush section 302 can, additionally or alternatively, include one or more flossing structures (not shown). Flossing structures can be semi-rigid structures configured to act alone or concert with the flexible brush bristles during use of the electric toothbrush.

Motion transmission assembly 310 includes an elongated motion arm 312 and a spring 314. Spring 314 can be a compression spring disposed around elongated motion arm 312. Elongated motion arm 312 can extend longitudinally within the stem 346. In some embodiments, elongated motion arm 312 can be a two-piece construction. For example, elongated motion arm 312 can include a proximal end portion 320 and a distal end portion 318, which can be two distinct members. Distal end portion 318 can be a rod that fits within a cavity of proximal end portion 320 (e.g., like a piston and cylinder style configuration). In other embodiments (not illustrated), proximal end portion 320 can include a rod that fits within a cavity of distal end portion 318. Distal end portion 318 can be coupled to the brush section.

Proximal end portion 320 of the elongated motion arm 312 can include a shaft coupling portion 316. The shaft coupling portion 316 can be substantially as described above, and be used in conjunction with, for example, an elastomeric pad. Proximal end portion 320 can further include a narrowing 322, which can serve to allow proximal end portion 320 to flex.

Motion transmission assembly 310 is configured to receive substantially linear (i.e., longitudinal) motion from the driveshaft and turn the linear motion into rotational motion of the brush section. For example, the brush section can rotate about an axis transverse to the longitudinal axis of the stem 346 of the brush head. Specifically, as illustrated and described above with respect to brush head 100 in FIG. 7, bristle plate 306 can rotate about a bristle plate pin. Elongated motion arm 312 can be eccentrically attached to brush section 302 (i.e., bristle plate 306). The eccentric attachment can occur at slot 333, which receives motion arm pin 332. The eccentric attachment permits the linear motion of elongated motion arm 312 to be transferred into rotational motion of the bristle plate 306. The eccentric attachment can be achieved using a pin and slot or similar attachment, as described above. In some embodiments, elongated motion arm 312 may include an offset portion to achieve the eccentric attachment.

Spring 314 of motion transmission assembly 310 is configured to bias elongated motion arm 312 in a proximal direction relative to the stem 346. In other words, spring 314 pushes elongated motion arm 312 in the proximal direction to ensure contact between elongated motion arm 312 and the driveshaft. As shown in FIG. 18, spring 314 is disposed around a portion of elongated motion arm 312. As shown and described above with respect to brush head 100, the inside of stem 346 can include one or more ribs. In addition to providing structural reinforcement for stem 346, the ribs can be positioned and otherwise configured to contact a distal end of spring 314.

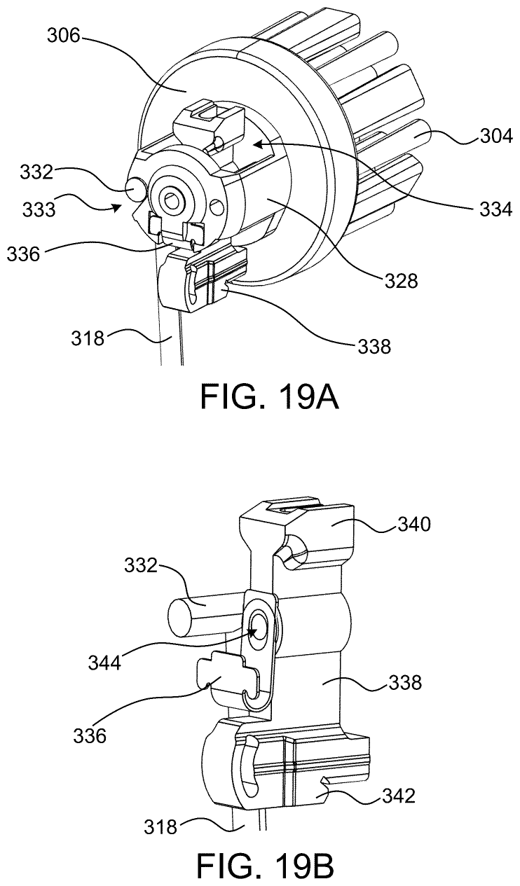

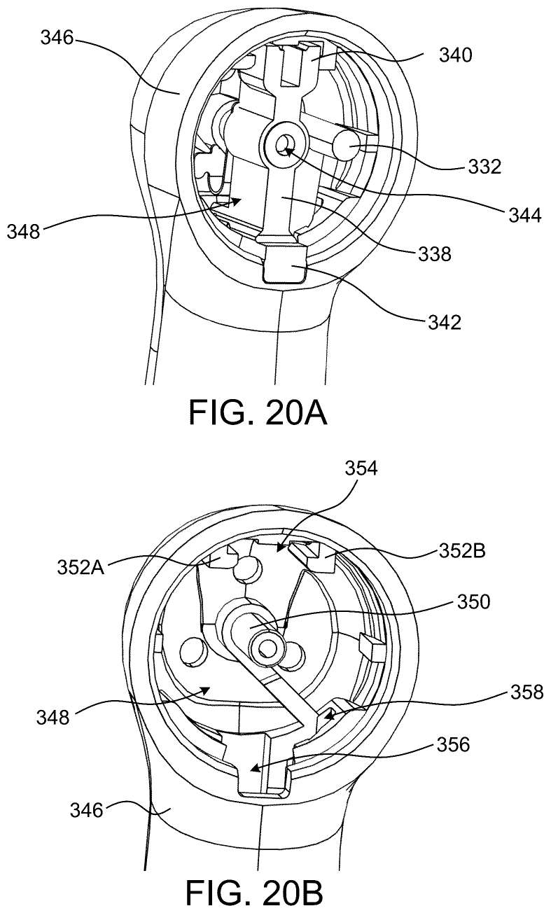

FIGS. 19A and 19B illustrate portions of the example interior structure of a toothbrush head at the distal end. Bristle plate 306 can have a bristle plate extension 328 extending reward from the bristle plate and form an opening 334. A stabilizing member 338 can extend through opening 334 and serve to stabilize bristle plate 306 and limit its range of motion. Spring clip 336 secures stabilizing member 338 to bristle plate extension 328. Referring to FIGS. 20A and 20B, stabilizing member 338 can have a top 340, a bottom 342, and a bore 344. Stabilizing member 338 can be disposed in an opening 348 of the head of stem 346. Top 340 of stabilizing member 338 can be retained by top protrusions 352A/352B extending into opening 348 from stem 346 and forming top channel 354. Similarly, bottom 342 of stabilizing member 338 can engage with bottom channel 356.

Stem pin 350 can be integral to stem 346 and extend into opening 348. Bristle plate 306 can rotate about stem pin 350. Stem pin 350 can extend through bore 344, spring clip 336, and bristle plate extension 328 to connect the bristle plate 306, stem 346, and stabilizing member 338. Relative motion applied to bristle plate extension 328 by elongated motion arm 312 (via slot 333 from motion arm pin 332) can cause the bristle plate to rotate about stem pin 350.

The various embodiments disclosed in this patent document provide advantages over the prior art, whether standalone or combined. For example, the disclosed embodiments use non-magnetized structures to couple a brush head to an electric toothbrush handle. These can reduce potential for corrosion caused by metallic magnetic structures. Disclosed embodiments improve secure attachment of the brush through use of, for example, one or more springs to provide an attachment force. Additionally, some embodiments, for example, those incorporating an elastomeric pad, can reduce overall vibration in the brush head during use while still transferring motion of the driveshaft to the brush section to cause desired rotation of the brush section.

Disclosed embodiments also provide the advantage of being able to preassemble the brush head (insert the coupling member and elongated motion arm into the brush head), which can permit distribution of the assembled brush head, limiting assembly by the end user and thereby simplifying and improving the user's experience.

Other advantages of the present invention can be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described in this document, but is intended to include all changes and modifications that are within the scope and spirit of the invention as defined in the claims.

1. A toothbrush head for an electric toothbrush, the toothbrush head comprising:
a brush section having a plurality of bristles attached thereon;
a stem having an opening for receiving a driveshaft of an electric toothbrush; and
a motion transmission assembly disposed within the stem comprising:
a first spring;
an elongated motion arm having a distal end portion and proximal end portion, the distal end portion being coupled to the brush section;
a driveshaft receiver engaged with the proximal end portion of the elongated motion arm; and
a second spring biasing the elongated motion arm and the driveshaft receiver apart from each other and configured to transfer motion from the driveshaft receiver to the elongated motion arm;
wherein the first spring is configured to bias the elongated motion arm in a proximal direction relative to the stem.

2. The toothbrush head of claim 1, wherein the driveshaft receiver comprises a proximal end having a shaft coupling portion and a distal end having a cavity.

3. The toothbrush head of claim 2, wherein the second spring is disposed within the cavity of the driveshaft receiver.

4. The toothbrush head of claim 2, wherein the proximal end of the elongated motion arm comprises a sidewall forming a cavity sized and shaped to receive the distal end of the driveshaft receiver.

5. The toothbrush head of claim 4, wherein:
the distal end of the driveshaft receiver further comprises a protrusion;
the side wall of the proximal end of the elongated motion arm comprises a slot; and
the protrusion of the driveshaft receiver engages the slot and is configured to limit a range of relative motion between the driveshaft receiver and the elongated motion arm.

6. The toothbrush head of claim 1, wherein the elongated motion arm is eccentrically coupled to the brush section and is configured to cause rotation of brush section in response to movement of the elongated motion arm.

7. The toothbrush head of claim 1, wherein the first spring is disposed around a portion of the elongated motion arm.

8. The toothbrush head of claim 1, wherein driveshaft receiver further comprises a plurality of lugs.

9. The toothbrush head of claim 1, further comprising a coupling member disposed within the stem.

10. The toothbrush head of claim 9, wherein the coupling member further comprises:
a sidewall forming a body of the coupling member and defining an opening for receiving the driveshaft; and
a longitudinal slot formed in the sidewall and configured to receive an indexing ridge and pin of the driveshaft.

11. A toothbrush head for an electric toothbrush, the toothbrush head comprising:
a brush section having a plurality of bristles attached thereon;
a stem having an opening for receiving a driveshaft of an electric toothbrush; and
a motion transmission assembly disposed within the stem comprising:
a spring; and
an elongated motion arm having a distal end portion and proximal end portion, the distal end portion being coupled to the brush section;
wherein the spring is configured to bias the elongated motion arm in a proximal direction relative to the stem.

12. The toothbrush head of claim 11, wherein the motion transmission assembly further comprises an elastomeric pad disposed between the proximal end portion of the elongated motion arm and the driveshaft.

13. The toothbrush head of claim 11, wherein the proximal end portion of the elongated motion arm comprises a shaft coupling portion.

14. The toothbrush head of claim 13, wherein the shaft coupling portion further comprises a plurality of lugs.

15. The toothbrush head of claim 14, wherein the lugs are configured to engage with corresponding receptacles of the driveshaft.

16. The toothbrush head of claim 11, wherein the elongated motion arm is eccentrically coupled to the brush section and is configured to cause rotation of brush section in response to movement of the elongated motion arm.

17. The toothbrush head of claim 11, further comprising a coupling member disposed within the stem.

18. The toothbrush head of claim 17, wherein the coupling member further comprises:
a sidewall forming a body of the coupling member and defining an opening for receiving the driveshaft; and
a longitudinal slot formed in the sidewall and configured to receive an indexing ridge and pin of the driveshaft.

19. The toothbrush head of claim 11, the spring is disposed around a portion of the elongated motion arm.

20. The toothbrush head of claim 11, wherein the elongated motion arm comprises two distinct members.
